(19) United States
(12) Patent Application Publication
(10) Pub. No.: US 2007/0069976 A1
(43) Pub. Date: Mar. 29, 2007

(54) Method and system for interface between head mounted display and handheld device

(76) Inventors: Bruce A. Willins, East Northport, NY (US); Richard Vollkommer, Smithtown, NY (US)

Correspondence Address: FAY KAPLUN & MARCIN, LLP, 15O BROADWAY, SUITE 702, NEW YORK, NY, 10038, US

(21) Appl. No.: 11/235,459

(22) Filed: Sep. 26, 2005

(51) Int. Cl. G09G 5/00

(52) U.S. Cl. 345/8

(57) ABSTRACT

Described is a head mounted display device which includes a mounting attachment to attach the head mounted display to a user and a radio frequency transceiver to communicate with a computing device, wherein the computing device formats and transmits video signals for output on the head mounted display. A display screen positionable in front of an eye of the user displays video content included in the video signals transmitted from the computing device.

### BACKGROUND INFORMATION

In the recent years, processor and circuit board technology has advanced at a rapid pace resulting in continual miniaturization of these components as well as computing devices in general. The miniaturization of electronic components has had a direct impact on handheld computing devices (e.g., cellular phones, PDAs, smart phones, mp3 players, etc.) because they benefit the most from a reduced size. The smaller size of handheld devices (HHD) facilitates their handling and use. However, the smaller size also results in design problems. Although the internal components of the HHDs have been sufficiently miniaturized, the external components, specifically input and output components (e.g., keypads, touchpads, displays, etc.) are limited not by technology but by the limitations of human physiology. More specifically, a keypad may not be so small that it is hard for the user to press the individual keys (e.g., the user, when attempting to press a specific key, would also activate the neighboring keys). The display must be large enough for the user to easily read its contents.

The newer HHDs have a smaller display which has to be proportional to other miniaturized components. The smaller display poses a number of disadvantages when displaying text documents or other data. The designers of the HHD have usually provided a number of limited solutions to this problem. The HHD may display the text in smaller font to maintain the format of the documents thereby making it harder for the user to read the text. Conversely, the HHD may display the text in a relatively large font destroying the original format of the text document (e.g., an email message is displayed one word at a time on a 100×100 pixel display).

Therefore, the size of the HHD may not be decreased beyond a certain threshold because it is limited by human physiology (e.g., finger size, eye sight, etc.). This leads to specialized HHDs (e.g., pager, cellular phone, etc.) which are optimized for a single function. For instance, a cellular phone, while especially designed for making phone calls is poorly suited for displaying visual content (e.g., email messages). Thus, a typical HHD user has to carry around multiple devices which are suited for a specific task. Certain multifunction devices attempted to rectify the problem of having to carry multiple devices by incorporating multiple devices into one unit. However, these devices generally implement all of the functions poorly and still suffer from an inadequate user input and output interfaces. Thus, there is a need for an apparatus that performs multiple computing functions and alleviates the problems associated with miniaturized input and output components

### SUMMARY OF THE INVENTION

A head mounted display device which includes a mounting attachment to attach the head mounted display to a user and a radio frequency transceiver to communicate with a computing device, wherein the computing device formats and transmits video signals for output on the head mounted display. A display screen positionable in front of an eye of the user displays video content included in the video signals transmitted from the computing device.

In addition, A system including a computing device formatting video signals and transmitting the video signals via a radio frequency transceiver. A head mounted device including a radio frequency transceiver to receive the video signals from the computing device, a display screen positionable in front of an eye to display video content included in the video signals transmitted from the computing device.

Furthermore, a method which includes executing an application on a hand held computing device, configuring display information of the application for a display that is external to the hand held computing device, transmitting the display information to a head mounted display device, wherein the display information is transmitted via a radio frequency signal and displaying the display information on the head mounted display device.

### BRIEF DESCRIPTION OF THE DRAWINGS

FIG. 1 is an exemplary embodiment of a head mounted display system according to the present invention;

FIG. 2 is an exemplary embodiment of a device driver for the head mounted display and a handheld device according to the present invention; and

FIG. 3 is an exemplary embodiment of a method for interfacing the head mounted display and the handheld device according to the present invention.

### DETAILED DESCRIPTION

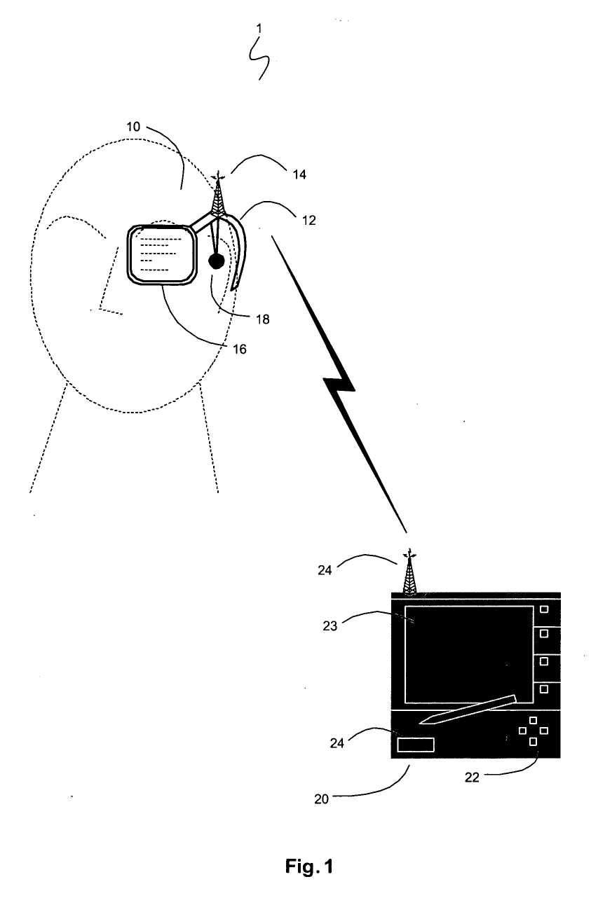

The present invention may be further understood with reference to the following description and the appended drawings, wherein like elements are provided with the same reference numerals. The present invention discloses a system 1 comprising a handheld device (HHD) 20 and a head mounted display (HMD) 10 as shown in FIG. 1. The system 1 provides for the splitting of the functionalities of a conventional handheld device. Specifically, the main computing functionality and the primary output functions into two devices—the HHD 20 and the HMD 10. The HHD 20 carries out the computing functions while the HMD 10 is responsible for output functions (e.g., displaying video output, playing audio output, etc.). This provides the user with a better video display because the HMD 10 includes a display that appears much larger to the user (e.g., the appearance of a 15″ monitor) than the conventional displays included with traditional handheld devices (e.g., 2″×3″).

The HHD 20 maybe any type of handheld device. However, the exemplary embodiment of the present invention may be particularly useful with an HHD having a small display. The HMD 10 will allow the small display of the HHD to be freed up for other tasks (e.g., touchscreen input) or supplementary displays. The following will describe an exemplary HHD 20. However, those of skill in the art will understand that any type of HHD 20 with various hardware and software functionalities may be used within the system 1. The only requirement for HHD 20 is that it contain the necessary hardware and software to interface with the HMD 10. The exemplary HHD 20 includes a radio frequency transceiver 24, a display 23, a keypad 22, and a sound input/output 25 (e.g., a speaker, a microphone, a headphone jack, etc.). The HHD 20 also includes volatile and non-volatile memory, a processor, a power source, additional hardware and internal circuitry, and software loaded into memory (e.g., operating system, applications, etc.) to accomplish the tasks assigned to the HHD 20.

The RF transceiver 24 allows the HHD 20 to communicate wirelessly on a plurality of wireless networks (e.g., wide area and local area networks). The RF transceiver 24 may include any of the necessary components to enable communication on the various types of wireless networks. For instance, the RF transceiver 24 may be compliant with various cellular service provider networks or wide area wireless broadband networks. This allows the HHD 20 to access the Internet, email, as well as make phone calls. In addition, the RF transceiver 24 may be compliant with the IEEE 802.11 protocol enabling it to communicate on local wireless networks. This capability allows the HHD 20 to access wireless networks through access points where the HHD 20 may connect to other computing devices on the network.

Furthermore, the RF transceiver 24 may be capable of communicating wirelessly on short range networks (e.g, Bluetooth, IR, etc.). Bluetooth or other RF communications allow the RF transceiver 24 to interface the HHD 20 with other devices communicating on the same protocols. Bluetooth has a range of approximately 30 feet (10 meters), and the devices using Bluetooth must use compatible versions of Bluetooth. Bluetooth provides a method for different devices to communicate with each other by sending data via a secure, low-cost short-range radio frequency. Thus, using the technology, PCs communicate with to printers or keyboards, handheld devices can communicate with each other without any wires, and the HHD 20 can communicate with headsets (e.g., HMD 10). Under the current standard, up to seven connections may be made at one time, at a speed of 1 Mbps. All that is needed to establish a connection between any two Bluetooth-enabled devices is a “handshaking” process that takes seconds and can be found in most wireless connectivity menus.

The keypad 22 of the HHD 20 may be any input component that includes keys associated with commands and/or characters. The keypad 22 maybe a number pad, a QWERTY keyboard, or a variant thereof. Using the keypad 22 the user may enter commands into the HHD 20 and create various text documents (e.g., email, text messages, etc.). The HHD 22 may include other input components (e.g., touchpad), however, these components may be superseded by including a touchscreen with the display 23.

The display 23 may be an LCD display typically found in PDA's and cellular phones. A typical display 23 is a color display that supports 16 bit color mode with a size of 240×320 pixels. In addition, the display 23 may be an active matrix display based on TFT technology. Although the HMD 10 will provide the primary video display to the user, the display 23 may still be used as a secondary video output. Specific secondary functionalities of the display 23 are discussed below. Those of skill in the art will understand that the described display is only exemplary and that the display 23 may be any type of display or that it is possible for the HHD 20 to not include a display because the HMD 10 may provide all display functionality within the system 1.

The display 23 may include a touchscreen (not shown). The touchscreen provides additional input and may be included in the display 23 if the HHD 20 does not include the keypad 22. A basic touchscreen has three main components: a touch sensor, a controller, and a software driver. The touchscreen is an input device that is combined with the display 23 and the HHD 20 to make a complete touch input system. A touch screen sensor is a clear glass panel with a touch responsive surface. The touch sensor/panel is placed over the display 23 so that the responsive area of the panel covers the viewable area of the display 23. The sensor generally has an electrical current or signal going through it and touching the screen causes a voltage or signal change. This voltage change is used to determine the location of the touch to the screen. The controller connects the touch sensor and the HHD 20. It translates voltage changes into data signals that the HHD 20 can understand. The driver is software within the HHD 20 that allows the HHD 20 to interpret the touch event information that is sent from the controller.

The touchscreen allows the display 23 to function as an alternative input means. The touchscreen may emulate the keypad 22. For instance, the touchscreen may generate a QWERTY keyboard to allow the user to type an email using the HHD 20. The QWERTY keyboard may be displayed on the display 23 in landscape format in order to maximize the output area. In addition, the touchscreen removes the need for the touchpad because the touchscreen provides the HHD 20 with pointer input technology without the need of additional components that require space on the HHD 20.

The sound I/O 25 includes speaker(s), microphone, and/or input and output jacks compatible with these components. The sound I/O 25 allows the HHD 20 to function as a cellular phone because the HHD 20 has wireless capability due to the RF transceiver 25. The sound I/O 25 also gives additional sound recording and playback capabilities to the HHD 20 (e.g., mp3 player, voice and/or memo recorder, etc.). Furthermore, the sound I/O 25 may provide the HHD 20 with automatic speech recognition (ASR) technology where the HHD 20 may be programmed to recognize certain phrases and execute them like any other command (e.g., a phrase “email” would open the email browser).

The HMD 10 is another component of the system 1 and it includes a head mounted (HM) display 16, a headphone 18, an HM RF receiver 14, and a mounting attachment 12 that is used to mount the HMD 10 on the user's head. It should be noted that throughout this description, the HMD 10 is described as including HM RF receiver 14. However, the HMD 10 may include a transceiver rather than a receiver, allowing the HMD 10 to both receive and transmit signals. The HMD 10 may also include volatile and non-volatile memory, a processor, a power source, and any other hardware and internal circuitry which are necessary. The HHD 20 performs all of the processing functions of the system 1, while the visual and audio output may be provided by the HMD 10 through the HM display 16 and the headphone 18, respectively.

The HMD 10 is worn on the user's head so that the HM display 16 is positioned in front of the user's eye. Those skilled in the art will understand that the HM display 16 may be of various shapes and sizes. For instance, the HM display 16 may be 0.5″×1″ and be positioned in front of one eye or it may be in shape of conventional glasses and be positioned in front of both eyes. The HM display 16 may be positioned in close proximity to the user's eye(s) (e.g., 0.4″ to 5″). The short distance from the eye to the HM display 16 and the display's relatively small size allow the HM display 16 to display more video data at higher resolution than a conventional display on a hand-held device, thereby making the video output on the HM display 16 easier to read.

The HM display 16, outputs video content transmitted from the HHD 20. For example, if the HHD 20 is running an email application, an email message may be displayed on the HM display 16. This is an exemplary embodiment and those skilled in the art will understand that the HM display 16 acts as the main video output for the system 1, while the display 23 of the HHD 20 acts as a secondary video output as discussed in further detail below.

The HM display 16 may be, for example, an LCD or an organic light-emitting diode (OLED) display. The OLED display includes a carbon-based film sandwiched between two charged electrodes, one a cathode and one a transparent anode (e.g., glass). The organic films include a hole-injection layer, a hole-transport layer, an emissive layer and an electron-transport layer. When voltage is applied to the OLED cell, the injected positive and negative charges recombine in the emissive layer and create electro luminescent light. Unlike LCDs, which require backlighting, OLED displays are emissive devices—they emit light rather than modulate transmitted or reflected light. Thus, OLED displays can be transparent while displaying information, thereby allowing the user to view their surroundings and the video information at the same time.

The display 23 of the HHD 20 is not large enough to alleviate problems of the prior art, therefore, the HM display 16 is used as the main display in the system 1. The HM display 16 may have a much higher resolution than the display 23 of the HHD 20 while being much smaller. The display 23 may be approximately 240×320 pixels while being 2.5″ wide and 3″ tall. In contrast, an HM display 16 may be only 0.75″ wide and 1″ tall while having a resolution of 800×600 pixels (e.g, VGA or better resolution). This increase in resolution allows the HMD 10 to display much more visual data on the screen than displays of conventional handheld devices. In addition, the decreased size of the HM display 14 allows the HMD 10 to be light enough for the user to wear on their head with little discomfort.

The HM RF receiver 14 is an RF receiver capable of communicating with the RF transceiver 24 using short range RF transmissions (e.g., the HM RF receiver 14 is a Bluetooth slave device). The HM RF receiver 14 may also be an RF transceiver allowing the HMD 10 to send signals to the HHD 20. In such a configuration, the HMD 10 may also be used as an input device. The communications received by the HM RF receiver 14 may include visual and sound output data from the HHD 20. Therefore, the RF transmissions must include sufficient bandwidth to facilitate transmissions of such data. As discussed above, Bluetooth is a preferable protocol for such communications because it allows for transmission rates as fast as 12 Mbps (e.g., Bluetooth 2.0). However, any protocol that supports a bandwidth sufficient for the operation of the HMD 10 may be used. Those skilled in the art will also understand that the wireless connection between the HHD 20 and the HMD 10 may be substituted by a wired one. However, the wired connections lacks the utility and comfort associated with unwired devices discussed in this exemplary embodiment.

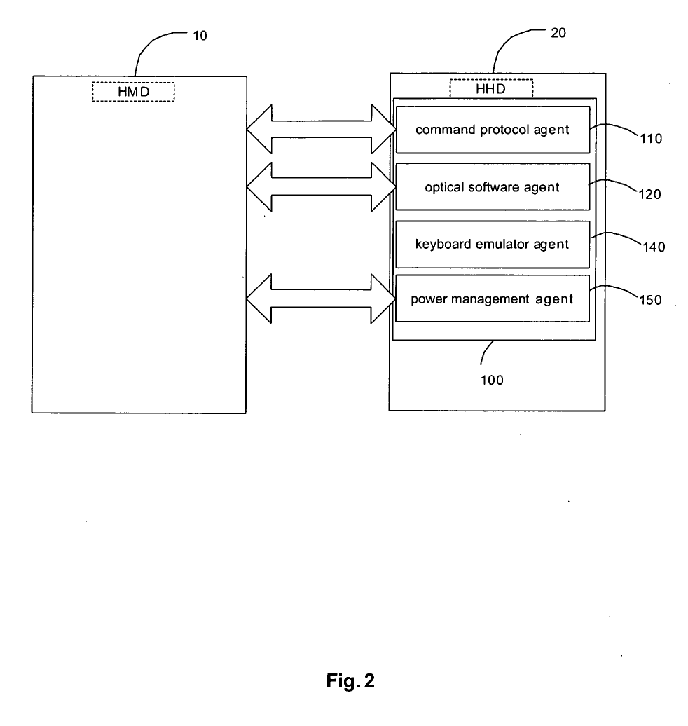

FIG. 2 is an exemplary embodiment of a device driver 100 allowing an interface between the HMD 10 and the HHD 20 according to the present invention. As shown in FIG. 2, the device driver 100 includes various agents 110-150 to perform different functionality to allow the HMD 10 to operate as the visual and audio output for the HHD 20. Each of the various agents 110-150 will be described in detail below. However, those of skill in the art will understand that a device driver may include more or less of the agents and/or functionality described for the exemplary device driver 100, i.e., the designer of the HHD 20, HMD 10 and/or device driver may elect the functionality that they desire for the HMD 10 to perform for the HHD 20 and provide a driver that meets the needs for the desired functionality.

The HHD 20 will discover or recognize that the HMD 10 is available for use with the HHD 20. For example, as part of a start-up operation, the HHD 20 may send a signal to all available peripheral devices to determine the type of peripheral devices that are available. The peripheral devices (e.g., the HMD 10) may respond to the signal indicating that the HMD 10 is available for use. In response, the operating system (or other software) of the HHD 20 may initiate the device driver 100 so that the HMD 10 acts as the audio and video output for the HHD 20. In another example, the HMD 10 may send a signal when it becomes available (e.g., when it is turned on). The HHD 20 will receive the signal, understand the HMD 10 is available and initiate the device driver 100 to operate with the HMD 10. If the HMD 10 is not available (or becomes unavailable during use) an alternate device driver for the display screen 23 of the HHD 20 may be used instead.

The following is a description of exemplary components and functionality of the device driver 100 for an enhanced input/output (I/O) device, e.g., the device driver 100 for the HHD 20 includes a command protocol agent 110 that maps and transfers commands entered on the HHD 20 to the HMD 10. Each of these components may be considered device drivers by themselves and the grouping of these components as agents within a larger device driver 100 for the HMD 10 is only exemplary.

The commands transferred by the command agent 110 may be commands pertinent to displaying text and other visual information on the HM display 16 so that the results of the commands are registered on the HM display 16. For example, while the HHD 20 is running an email application, when a “down arrow” key is pressed on the keypad 22 or the touchscreen of the display 23 the text scrolls down on the HM display 16 proportionally to its dimensions. Thus, if a scroll down action would have produced a shift of 10 pixels in a 240×320 pixel display, it would produce an approximately 20 pixel downward shift in a 800×600 pixel HM display 16.

In order for commands to be properly transferred they must be non-stateful. A stateful command maintains the internal state of its data and variables specific to each individual use. A non-stateful command modifies the data contained therein based on the individual execution. Thus a different result is accomplished when the scroll command from the above example is executed on the HM display 16 and not the display 23.

In addition, certain key commands and ASR commands local to the HHD 20 may be mapped to the HMD 10 using the command agent 110 thereby allowing the commands to control the HMD 10. Since the HHD 20 includes the sound I/O 25 it may also include internal components that allow the HHD 20 to have speech recognition technology. In one exemplary embodiment, the ASR technology allows the user to speak preset phrases to invoke commands. For example, the user may speak the word “down” which is picked up by the headphone 18 of the HMD 10. The headphone 18 may act as both a speaker for audio output and a microphone for audio input. The audio signal for the word “down” may be transmitted from the HMD 10 to the HHD 20 wherein the ASR technology recognizes the word “down.” The user may then map the word “down” with a command to scroll down a predetermined number of lines of text. Thus, when the user speaks the word “down,” the HHD 20 may recognize this as a command to scroll the display down a predetermined number of lines of text. Other ASR commands may be mapped in a similar manner.

Furthermore, the mapping is not limited to ASR commands. It may be possible to include different sensors on the HMD 10 to indicate various actions or movements of the user (e.g., blinking of the eye, turning of the head). These movements may also be mapped to various commands. Also, the same actions (e.g., speaking the word “down”), may be mapped to different commands for different applications on the HHD 20.

In addition, the command agent 110 is configured to display command confirmations on the display 23. Although the HM display 16 is the primary video output, the display 23 may function as a secondary display and output command confirmations. Thus, when the user inputs a command via ASR or through other means, the display 23 may display the entered command and await confirmation from the user prior to actually executing the command. This functionality is particularly useful during continuous data entry involving ASR because speech recognition technology is prone to errors. For example, if the user is filling out a digital document form that is displayed on the HM display 16, the ASR entries may be first displayed on the display 23 prior to being entered into the document. In addition, this configuration requires the HHD 20 and HMD 10 to communicate only once during the two-step command entry (i.e., first step is the command confirmation, second step is the command entry). Although the confirmation and the entry of the command is a two step process, the confirmation step does not involve the HMD 10 thereby saving power by cutting down the number of transmissions between the HHD 20 and the HMD 10, while maximizing the data entry process.

As discussed above, the HHD 20 may use the HMD 10 as the primary display for video data. This allows the display 23 to be freed up for other secondary functions. For example, the display 23 may be used as a touchscreen keypad. On simple handheld devices, the keypad is sometimes extremely small and difficult to use. Thus, by freeing up the display screen 23, a user may then have access to a larger keypad that is more ergonomically efficient to use than the normal keypad.

In such a case, the HHD 20 may include a dedicated keyboard emulator agent 140 which transforms the display 23 into a keypad by displaying keys and emulating a keyboard once the HHD 20 is connected to the HMD 10. The emulated keypad maybe a QWERTY type keyboard or a numpad, depending on the function being performed by the HHD 20. For instance, if the HHD 20 is being used as a cellular phone, the display 23 would display a numpad allowing a user to enter a phone number. However, if the user types an email, the HHD 20 may display a regular QWERTY keyboard.

Those of skill in the art will understand that the keyboard emulator agent 140 described above, does not have any interaction with the HMD 10 and, therefore, may not be included as part of the device driver 100 for the HMD 10. However, the keyboard emulator agent 140 may be dependent on the HMD 10 being available and may only be invoked when the HHD 20 becomes aware of the HMD 10. Thus, a device designer may decide to include the keyboard emulator agent 140 as part of the device driver 100 or as a separate driver for the display screen 23.

In order for the video output signal to be properly transferred, the HHD 20 also needs to be aware of the optical characteristics of the HMD 10. The HHD 20 includes an optical software agent 120 including software drivers that allow the HHD 20 to communicate with the HM display 16. Those of skill in the art understand that there are numerous manners of loading the correct software drivers on the HHD 20. For example, when the system 1 is initialized, the HHD 20 may read information from the HM display 16 (or the HM display 16 may send a message to the HHD 20) which indicates the display type of the HM display 16. The HHD 20 may then select the correct driver(s) for that display type from a list of loaded drivers. If the list does not include the correct driver(s), the HMD 20 may prompt the user (on display 23) to load the correct set of driver(s). Other manners of using the loading and using the software driver(s) are known in the art.

As described above, the optical agent 120 will be made aware of certain properties of the HM display 16 (e.g., resolution, refresh rate, color depth, etc.). Access to this information allows the HHD 20 to format the visual data for optimal display. For example, if the HHD 20 intends to display an image on the HM display 16 that takes up 25% percent of the display 23, the size of the image is increased to make the image to be 25% of the HM display 16 as well (because the HM display 16 has a higher resolution the display 23).

Short range RF transmissions (e.g., Bluetooth) consume a relatively large amount of electrical power. Therefore, the system 1 includes a power management agent 150. The power management agent 150 is configured to ensure that power is consumed efficiently by the HHD 20 and HMD 10. The power management agent 150 may control the amount of time the display 23 and the HM display 16 are turned on and their brightness. Thus, if the HMD 10 is not being used it would turn off until it is reactivated. In addition, updates from the HHD 20 to the HMD 10 may be timed to occur during specific periods to allow both devices to conserve power by not maintaining continuous radio contact. Furthermore, the command confirmation functionality of the command agent 110 also aids in power conservation.

In an alternative embodiment, it is possible to include certain functionality in the HMD 10 separate from the HHD 20. For example, the HMD 20 may include a separate processor/memory which includes functionalities such as ASR and power management. An advantage of such an arrangement is that it may reduce the number of communications between the HHD 20 and the HMD 10 capabilities. However, providing the HMD 10 with a separate processor/memory arrangement entails additional cost for the components.

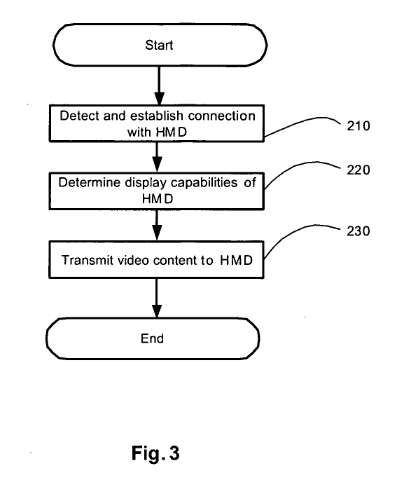

FIG. 3 shows an exemplary method for interfacing the HHD 20 with the HMD 10 according to the present invention. As described above, the HHD 20 will include a device driver that is specific for the HMD 10 to allow the HHD 20 and the HMD 10 to interface. Thus, each of the steps of FIG. 3 may be carried out using various functionalities of the specific device driver loaded onto the HHD 20 for the HMD 10.

In step 210, the HHD 20 and the HMD 10 are activated and establish wireless communications. In an exemplary embodiment, the HHD 20 and HMD 10 communicate using Bluetooth. Thus, the HHD 20 and the HMD 10 perform the Bluetooth “handshaking” process to detect each other and establish a communication path. If the devices use other communication protocols, the HHD 20 and the HMD 10 will establish communications based on the requirements of those protocols.

In step 220, the HHD 20, using the optical agent 120, determines the display capabilities of the HM display 16 (e.g., resolution, refresh rate, screen size, etc.). These properties allow the optical agent 120 to format the video output signals that are transmitted from the HHD 20 to the HMD 10 so that they are properly displayed on the HM display 16 (i.e., the images are not truncated, the font is of appropriate size, etc.).

In step 230, the HHD 20 transmits video output signals to the HMD 10 using the agents shown in FIG. 2 to format the video content. In addition, the agents of the HHD 20 are also utilized to provide a command interface between the HHD 20 and the HMD 10 so that the commands entered on the HHD 20 are registered on the HMD 10.

The present invention discloses a system for providing a better video display solution in handheld devices. By using the HMD 10 as the primary video output device the present invention overcomes the shortcomings of the prior art wherein the display size was too small. The HHD 20 is also superior to conventional multifunctional devices because it has more room for more powerful internal components since it longer needs to include a conventional display large enough to perform primary video output functions.

The present invention has been described with the reference to the above exemplary embodiments. One skilled in the art would understand that the present invention may also be successfully implemented if-modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A head mounted display device, comprising:
a mounting attachment to attach the head mounted display to a user;
a radio frequency transceiver to communicate with a computing device, wherein the computing device formats and transmits video signals for output on the head mounted display; and
a display screen positionable in front of an eye of the user to display video content included in the video signals transmitted from the computing device.

2. The head mounted device as recited in claim 1, wherein the computing device transmits audio signals to the radio frequency transceiver for output on the head mounted display, further comprising:
a sound output device positionable in proximity to an ear of the user to output the audio signals transmitted from the computing device.

3. The head mounted device as recited in claim 1, wherein the radio frequency transceiver receives an action command corresponding to an action of the head mounted display.

4. The head mounted device as recited in claim 3, wherein the radio frequency transceiver transmits a request command to the computing device, the action command being received in response to the request command.

5. The head mounted device as recited in claim 1, wherein the display screen is one of an LCD display and an OLED display.

6. The head mounted device as recited in claim 1, wherein the display screen has a resolution of at least 800×600 pixels.

7. A head mounted device as recited in claim 1, wherein the radio frequency transceiver communicates with the computing device using Bluetooth.

8. A system comprising of:
a computing device formatting video signals and transmitting the video signals via a radio frequency transceiver; and
a head mounted device including a radio frequency transceiver to receive the video signals from the computing device, a display screen positionable in front of an eye to display video content included in the video signals transmitted from the computing device.

9. The system as recited in 8, wherein the computing device further transmits audio signals via the radio frequency transceiver, the head mounted device further including a sound output device to output sound included in the audio signals transmitted from the computing device.

10. The system as recited in 8, wherein the computing device includes one of a display, a touchscreen, a keypad, a keyboard, and an audio input/output arrangement.

11. The system as recited in claim 8, wherein the computing device communicates via the radio frequency transceiver with one of a local area network and a wide area network.

12. The system as recited in claim 11, wherein the computing device communicates with the one of the local area network and the wide area network using an IEEE protocol.

13. The system as recited in claim 8, wherein the computing device communicates with the head mounted device using Bluetooth.

14. The system as recited in claim 8, wherein the computing device transmits an action command corresponding to an action of the head mounted device.

15. The system as recited in claim 14, wherein the head mounted device transmits a request command to the computing device, the action command being transmitted in response to the request command.

16. The system as recited in claim 15, wherein the computing device maps the request command to the action command.

17. The system as recited in claim 15, wherein the request command is an audio command and the computing device translates the audio command using automatic speech recognition (ASR) software.

18. The system as recited in claim 8, wherein the action command is a non-stateful command.

19. The system as recited in claim 8, wherein the computing device includes power management software which signals the head mounted device to enter a reduced power state.

20. A method, comprising the steps of:
executing an application on a hand held computing device;
configuring display information of the application for a display that is external to the hand held computing device;
transmitting the display information to a head mounted display device, wherein the display information is transmitted via a radio frequency signal; and
displaying the display information on the head mounted display device.
